(19) United States
(12) Patent Application Publication
(10) Pub. No.: US 2012/0059685 A1
(43) Pub. Date: Mar. 8, 2012

(54) System for Generating a Housing Price Index

(75) Inventors: Lars-Erik Ericson, Uppsala (SE); Han-Suck Song, Danderyd (SE); Mats Wilhelmsson, Bromma (SE)

(73) Assignee: VALUEGUARD INDEX SWEDEN AB, Uppsala (SE)

(21) Appl. No.: 13/319,028

(22) PCT Filed: May 6, 2010
(86) PCT No.: PCT/SE2010/000126

§ 371 Date: Nov. 14, 2011

Related U.S. Application Data
(60) Provisional application No. 61/176,743, filed on May 8, 2009.
(60) Provisional application No. 61/258,268, filed on Nov. 5, 2009.
(60) Provisional application No. 61/261,889, filed on Nov. 17, 2009.

(51) Int. Cl. G06Q 30/02

(52) U.S. Cl. 705/7.31; 705/7.29

(57) ABSTRACT

A computer system for automated generation of a housing price index is provided. The system can receive transaction data relating to the sale of a house or apartment and generate a hedonic price index based on the received transaction data for a specified period. The system can further be configured to continuously determine an estimate of the price index for the current period based on received new transaction data. The housing price index can be disseminated in real time, the method and system as described herein significantly reduces the risk for market manipulation and insider trading in a financial instrument relying on a housing price index. This is obtained by continuously generating an estimate of the index as deal data is generated an input into the system.

### TECHNICAL FIELD

The present invention relates to a method and a system for generating a housing price index. In particular the present invention relates to a method and system providing a fast and reliable index reflecting the change in value of a housing market.

### BACKGROUND

It is well recognized that a price index for housing having a good quality is desired. An index having a good quality can serve as a basis for a derivatives market where house owners can hedge against market changes using an insurance, see also the international patent application WO2008123817 incorporated herein by reference.

One way of constructing a price index is to use a hedonic approach, see Rosen, S. (1974). Hedonic Prices and Implicit markets: Product Differentiation in Pure Competition. Journal of Political Economy, and also “Construction and updating of property price index series: The case of segmented markets in Stockholm”; Mats Wilhelmsson (2009); Property Management Volume: 27 Issue: 2 Page: 119-137 incorporated herein by reference.

However, price indexes constructed by average price or average price per square meter do not control for different types of houses/apartments sold over time. Repeated-sales method has problem such as sample selection bias and parameter heterogeneity. Major drawbacks with the hedonic price index method are parameter heterogeneity and spatial dependency, as well as incorrect functional form, revision volatility, and omitted variable bias.

Also, when trading with financial instruments that are based on a housing price index, there is a need for protecting the market participants from insider trading as well as unfair distribution of information potentially affecting the price index.

Thus, there is a constant demand to increase the quality of housing price indexes and the way of distributing housing price indexes.

Hence, there exist a need for a method and a system that is able to provide a housing price index having a good quality and which is fast to generate and that can be disseminated and used as a basis for trading of financial instruments generated from the housing index.

### SUMMARY

It is an object of the present invention to overcome or at least reduce some of the problems associated with existing methods and systems for generating a housing price index.

It is another object of the present invention to provide a method and a system enabling efficient dissemination of housing price indexes.

It is yet another object of the present invention to provide a method and a system that is enables establishment of a housing price index that closely follows the changes in housing prices.

At least one of these objects and other objects are obtained by the method and system as set out in the appended claims.

Thus, in accordance with one embodiment a computer system for automated generation of a housing price index is provided. The system comprises a unit for receiving transaction data relating to the sale of a house or apartment. The system also comprises a module for generating a hedonic price index based on the received transaction data for a specified period. The module is further configured to continuously determine an estimate of the price index for the current period based on received new transaction data. The housing price index can be disseminated in real time.

In accordance with one embodiment a computer system for automated generation of a housing price index is provided. The system comprises a unit for receiving transaction data relating to the sale of a house or apartment. The system also comprises a module for generating a hedonic price index based on the received transaction data for a specified period. The module is further configured to include as one parameter in the generation of the hedonic price index, the distance to the center of the city.

In accordance with one embodiment a computer system for automated generation of a housing price index is provided. The system comprises a unit for receiving transaction data relating to the sale of a house or apartment. The system also comprises a module for generating a hedonic price index based on the received transaction data for a specified period, wherein the hedonic price index is generated using moving window regression.

Using the method and system as described herein will provide a housing price index that closely follows the real change in value for houses/apartments on a market reflected by the index. This is needed for a number of different purposes including enabling financial product like insurances against market changes for housing.

In addition the method and system as described herein significantly reduces the risk for market manipulation and insider trading in a financial instrument relying on a housing price index. This is obtained by continuously generating an estimate of the index as deal data is generated an input into the system. In accordance with one embodiment the estimate is generated and disseminated to market participants in real time.

The system can be implemented using computer servers running software arranged to perform various functions as described herein.

### BRIEF DESCRIPTION OF THE DRAWINGS

The present invention will now be described in more detail by way of non-limiting examples and with reference to the accompanying drawing, in which:

FIG. 1 is a view illustrating a system for generating and disseminating a housing price index, and

FIG. 2 is a flow chart illustrating some steps performed when managing outliers and observations with high leverage in the data.

### DETAILED DESCRIPTION

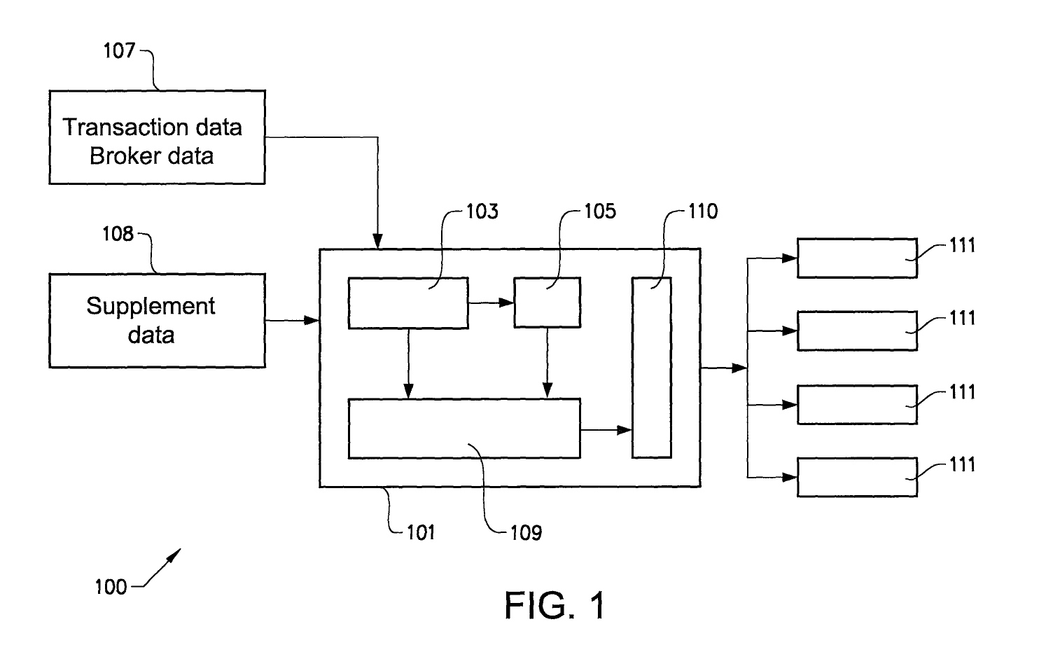

In FIG. 1 a view illustrating an exemplary system 100 for generating and disseminating a housing price index is shown. The system 100 can be used for index generation for all types of housing including but not limited to apartments and real estate. The system 100 comprises a central generator module 101 for generating a housing price index. The module in turn comprises a unit 103 for receiving external data. In addition the module 101 comprises a central data base 105 for storing data for transactions registered in the system 100, i.e. data relating to buying and selling of houses. The data stored in the data base 105 is received by the unit 103. The unit 103 can receive data from a number of different sources. In the embodiment depicted in FIG. 1, the unit receives data from a computer system 107 wherein real estate/apartment brokers register housing transactions and data relating to housing transactions. The data registered by the brokers can typically be the address of the house/apartment, the size thereof, the transaction price and the transaction date. Other data can also be registered as is described in more detail below. In addition, the unit 103 can be connected to other computer systems 108 comprising other data that can be used by the module 101 when generating a housing price index and which possibly is not available from the computer system 107. For example data relating to the neighborhood of a particular sold house/apartment can be retrieved.

When generating a housing price index, the module 101 uses a hedonic price equation. In accordance with one embodiment a moving window regression is used. The moving window approach compute regression parameter estimates for overlapping sub-samples. Hence, the first regression uses a cross-section subsample over, for example, the first twelve months in the sample. The second regression uses a cross-section from month two to month thirteen and so on. Thus, over a three year period 25 hedonic price equations can be estimated instead of one or 36. The advantage is that the hedonic prices can change over time.

Below some attributes that can be used as input data when generating the housing price index using a hedonic price equation in the module 101 for apartments are described in more detail. First, transaction of arm-length filtered and only such transactions are used. As apartment attributes, the size of the apartment together with number of rooms can be used. Both of them are hypothesized to have a positive effect on price. In addition the size, the monthly fee to the management of the house can be used. The effect is supposed to have a negative effect on price. Another apartment characteristic that can be used is whether the apartment has a balcony or not. Also, it is possible to include a number, for example three, of variables indicating where in the building the apartment is located. The first is the floor level and the other two are dummy variables indicating if the apartment is on floor 1 or the top floor. Floor one can be associated with a discount and the top floor (with a possible view) with a premium.

Only three property attributes are going to be used in this example, namely the age of the property, the height of the property and whether the property have an elevator or not. It is possible to form an interaction variable between elevator and floor. The hypothesis is that the household are not willing to pay a premium if the apartment are located on the first floor, but there will exist a willingness to pay for an elevator as we comes higher up in the property. The age of the property is a proxy for the quality of the property and the apartment, but instead of using a continuous variable, we have constructed seven different dummy variables. Our hypothesis is that relatively new and very old apartments are prices highest, while the apartment built during the “Million programme” are prices lowest.

| | |
|---|---|
| (1) New | |
| (2) Before 1900 | |
| (3) 1900-1939 | (Before Second World War) |
| (4) 1940-1959 | (War post-war period) |
| (5) 1960-1975 | (the “Million programme”) |
| (6) 1976-1990 | (Period with high construction subsidies) |
| (7) After 1990 | (Abolishment of the subsidy system) |

The information about the neighbourhood characteristics is scarce. By estimating the distance to the centre of the city, a price gradient can be estimated. Naturally, distance is supposed to have a negative effect on price. Also, in addition to distance, the city can be divided into a number of different geographical areas. For example the city can be divided into four quadrants (northwest, northeast, southwest and southeast). In order to reduce spatial dependency further, attributes for longitude and latitude coordinates can be added. Also, the city centre can be determined in various ways. One way is to determine the centre based on geographical data of the sales in the city. In accordance with one embodiment the sales can also be weighed with the price of a sale, thereby moving the determined city centre towards the area with the highest prices.

Furthermore, the hedonic model can include dummy variables concerning sub-markets. The submarkets can for example be defined as the administratively parish. The parish variables together distance variables are included as to reduce omitted variables bias and to mitigate spatial dependence.

Besides the apartment and property characteristics, as well as the neighborhood attributes, time dummy variables can be included in the hedonic price equation. The time-dummies are constructed using the date of transaction.

In table 1 below some of the above characteristics are shown for a set of transactions.

TABLE 1
Descriptive statistics.

| | | | Standard | | |
|---|---|---|---|---|---|
| Variable | Definition | Average | deviation | Min | Max |
| Price | SEK | 2168827 | 1287835 | 256250 | 9975000 |
| Living area | Square meters | 60.96 | 25.62 | 14 | 225 |
| Rooms | Number of rooms | 2.25 | 1.00 | 1 | 9 |
| Fee | Monthly fee: SEK | 2976.62 | 1268.56 | 1 | 11966 |
| Balc | Dummy: Balcony | 0.1200 | 0.3249 | 0 | 1 |
| First | Dummy: First floor | 0.1986 | 0.3990 | 0 | 1 |
| Top | Dummy: Top floor | 0.2973 | 0.4571 | 0 | 1 |
| Byear1 | Dummy: Before | 0.0580 | 0.2337 | 0 | 1 |
| | 1900 | | | | |
| Byear2 | Dummy: 1900-1939 | 0.3812 | 0.4857 | 0 | 1 |
| Byear3 | Dummy: 1940-1959 | 0.2321 | 0.4222 | 0 | 1 |
| Byear4 | Dummy: 1960-1975 | 0.0699 | 0.2550 | 0 | 1 |
| Byear5 | Dummy: 1976-1990 | 0.0496 | 0.2171 | 0 | 1 |
| Byear6 | Dummy: After 1990 | 0.2092 | 0.4067 | 0 | 1 |
| New | Dummy: | 0.0175 | 0.1310 | 0 | 1 |
| | New building | | | | |
| Elev | Dummy: Elevator | 0.5071 | 0.4924 | 0 | 1 |
| Distance | Distance: Meters to | 3882.35 | 2727.43 | 272.62 | 12987.20 |
| | city | | | | |
| NE | Dummy: Northeast | 0.1998 | 0.3999 | 0 | 1 |
| NW | Dummy: Northwest | 0.3151 | 0.4646 | 0 | 1 |
| SW | Dummy: Southwest | 0.1786 | 0.3830 | 0 | 1 |
| No. of | | 32,380 | | | |
| observations | | | | | |

using Box-Cox transformation to find the best fitting form indicates that a log-linear form can be used. The results are exhibited in the table below.

TABLE 2
Regression results (dependent variable = natural logarithm of price)

| Variable | Coefficient | t-value | VIF |
|---|---|---|---|
| Constant | −136.1965 | −7.59 | |
| Living area | 0.9035 | 89.27 | 6.17 |
| Rooms | 0.1243 | 25.15 | 4.69 |
| Fee | −0.2045 | −16.62 | 3.12 |
| Balc | 0.0122 | 3.07 | 1.46 |
| First | −0.0047 | −1.35 | 1.66 |
| Top | 0.0228 | 7.09 | 1.79 |
| Byear1 | 0.0591 | 11.48 | 1.60 |
| Byear2 | 0.0186 | 5.09 | 2.57 |
| Byear3 | −0.0140 | −3.22 | 2.29 |
| Byear4 | −0.1398 | −21.33 | 1.46 |
| Byear5 | −0.1413 | −17.38 | 1.47 |
| New | 0.0222 | 2.52 | 1.13 |
| Elev | −0.0117 | −3.71 | 1.96 |
| Dist | −0.2887 | −28.30 | 37.47 |
| Dist*NE | −0.0178 | −1.91 | 1055.74 |
| Dist*NW | 0.0839 | 5.59 | 2390.66 |
| Dist*SW | 0.0525 | 3.75 | 1320.92 |
| NE | 0.1719 | 2.49 | 925.99 |
| NW | −0.4283 | −3.73 | 2180.63 |
| SW | −0.2462 | −2.26 | 1257.40 |
| No. of | 31390 | | |
| observations | | | |
| R²-adj | .8780 | | |

Using the coefficients concerning the time dummies, a hedonic apartment price index for the city can be constructed.

In accordance with one embodiment when a new index is calculated, for example every day every week or every month, a new index number is estimated. For example if the index is updated every month, the index is updated using transaction eleven month prior to the new month plus the new month. At the same time, all old index numbers can be revised. With a moving window regression approach, the index number will be revised eleven times, that is to say, up to a year.

The method for generating a housing price index as described herein can also be combined with other methods for generating housing price indexes, such as a repeated sales method or a Case Schiller method.

Using the above method a housing price index having a good quality can be automatically generated by a housing price index generator 109 connected to the data base 105. In accordance with one embodiment the generator 109 is prompted to generate a new index every time new data is received by the unit 103.

By continuously generating a new index or an estimate for a current price index period and immediately disseminate the generated price index/price index estimation the market can be provided with real time housing price index data that can be used for updating prices on derivatives having the housing price index as an underlying trading instrument. The dissemination can be performed by a dissemination unit 110. The unit 110 is in turn connected to a number of receivers 111 connected to the system for receiving house price index data.

In one exemplary embodiment, the housing price index is updated and fixed once every month. However, as data is continuously received from brokers or some other data system where new transactions are registered, an estimate of what the housing price index is going to can start to be generated already in the beginning of a month. The estimate is then disseminated to the market for different uses, such as pricing information for housing price insurances and other financial instruments based on the index.

Thus, in accordance with one embodiment each month when a new index value is calculated, only the last data point is added to the index series. The new data can be subject to an automated quality check when entering new data into the system. The quality check can comprise procedural steps for making certain that the entered data is correct. The steps can include checking that the underlying sale is validly signed by all parties.

Although most sales transactions are available at calculation times of each index value, sometimes a number of sales transactions for an earlier period may not yet have been recorded at the time of index calculation. Normally, this has no significant effect to the index values. When this information becomes available it can be included in next month calculation, however this will only affect the new month value.

In accordance with one embodiment historical index numbers will not be changed when the index is updated with a new period. In order to keep historical index numbers unchanged, irrespective of changes in the underlying regression model specification or the arrival of new data, index numbers for new periods will be constructed to be equivalent to the percentage change in the price index between the new period and the period just before. This means that any estimated absolute index numbers will be adjusted to correspond to the historical numbers in terms of percentage changes in the price indexes, no matter what has happened to the historical index numbers due to specification changes or the arrival of new data. Hereby historic data will remain unaltered but the data and equation can be refined for future index values.

In accordance with one embodiment the module 101 receives location data for each sold house/apartment. Using the location data a centre of a city can be generated and the distance from the generated centre can be used in the regression for determining the different parameters.

In one exemplary embodiment the location of all apartment transactions in a city is used to generate the city center. In accordance with another embodiment the price or price per living area is used for determining the city center.

Other spatial parameters can also be used in any suitable combination. The spatial parameters can include but are not limited to sub-market, distance to sub market center, direction from center, direction from sub market center, parish, and administrative area.

In accordance with in embodiment, when determining a price index for a small city or region with few sales, the following method can be used. The long term change in the market is determined using sales from the city/region. However, because there are typically few sales in an individual month or even over a three month period in a small city, the price index over such a short term is supplemented with data from a larger region. The larger region can be similar city nearby or cities historically showing a close correlation with the city. To elaborate, sometimes there is too small amount of data to provide reliable statistics for a short term period, in this example on a month by month basis. On the other hand there can be a wish or even a demand to provide reliable data for such a period. This is the case for generating a housing price index, where different actors in the market demand index changes that can be relied on and which are not the result of one or two sales that represents deviations from the “true” market change. The solution is then to supplement the data from the small area for which the housing price index is to be generated for with data from a larger area. The larger area can then be selected to represent an area which is expected to have a close correlation with the smaller area or which historically has had a cloase correlation with the smaller area.

Below a figure illustration this approach is depicted.

The Figure shows the price index in small municipality together with the price index of the corresponding county over a time period. When generating a price index for the small area, in this case the municipality, a smoothened time series is first automatically generated by a dedicated computer, for example as a sliding average value. The result is depicted in the below figure.

It is noted that the price development follows the same underlying pattern, but that the amount of the change differs. In a next step, the price changes in the small area are used in combination with the price changes of the larger area. This is shown in the figure below.

The combined index value can be automatically generated by a computer in accordance with different methods. In accordance with one embodiment the combined index value can be generated as:

$$\frac{Index county 1 month}{Index county 12 months} * Index municipality 12 months$$

This method makes it possible to generate an index value for a small area with little data during a time period with high precision such that the generated price index can be relied upon. In accordance with another embodiment the short term data can be used for the smaller area, but not given a full weight, the rest of the weight is then given by the larger area in a combined index value. This would generate the below combined index value in the example given above.

In accordance with one embodiment a combined index is generated for a number of cities. The cities can typically be large cities of a country a region or any part of the world of particular interest. The cities of the area are selected based on the number of sales for a particular period. For example an index of 20 cities in Sweden can be generated by determining the 20 cities with the largest number of sales. An index for these 20 cities is then generated in accordance with the principles described herein with an appropriate weight. If in a subsequent period one of the cities no longer has generated enough sales that city is replaced by another city such that only the, for example, 20 cities with the most sales are part of the index

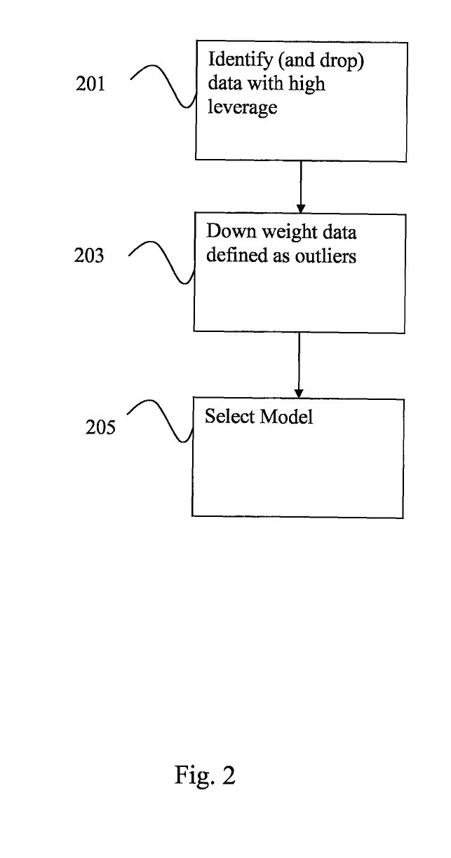

Furthermore, as has been realized, the presence of leverage and outliers can generate a problem in the estimation of real estate price indexes. In order o detect and mitigate the problem, a testing procedure and modeling as described below in conjunction with FIG. 2 can be utilized. Thus, a model is used to model the observed data taking into account and modeling observations determined to have high leverage and/or outliers.

FIG. 2 is a flow chart illustrating some steps performed when managing outliers and observations with high leverage in the underlying data used for determining an index as described above. First, in a step 201, observations with a high leverage are detected and in some cases deleted. An observation can for example be determined to be an observation with high leverage if one or many criteria are met. In one exemplary embodiment an observation can be determined to be an observation with high leverage if the observed value of the independent variable is further away from the average value than a pre-determined distance. A number of other different methods are available in order to detect observation with high leverage. Methods that can be used are, for example, ocular investigation, estimate the leverage value, and estimate measures that calculate the influential impact an observation have on the expected value of the dependent variable given all the independent variables.

It should be noted that observations with high leverage can be influential, but it is not a necessary condition. An influential observation can, for example, be detected by Cook's distance. It is measured as the absolute value of the difference in expected value with and without an individual observation included in the estimation. In accordance with one embodiment an observation with a Cook's distance larger than the critical value will be dropped from the estimation. Another measure that can be used is, for example, Welsch distance.

Next, in a step 203, the absolute errors, for example defined as observed price minus predicted price, are estimated in order to down-weight observations with large errors. In one exemplary embodiment observations that are considered to be outliers are given a lower weight than other observations. An outlier can be defined as an observation where the error is high. The down-weighting can be carried out with, for example, biweight (bisquare) transformation or Huber weights.

Thereupon, in a step 205, a model that best handles leverage and outliers is determined, using an out-of-sample prediction test. For example, the model that generates the lowest prediction error when comparing the predicted price compared to the actual price is determined and used to handle observations determined to be outliers and or generating high leverage. The model with, for example, the lowest root mean square errors can be chosen.

From an implementation point of view, the steps 201 and 203 can be implemented in the statistical program Stata (Robust regression) in a process of estimating real estate hedonic prices indexes as described above. In step 201, the statistical measure Cook's distance can be estimated in order to test whether an individual observation have a substantial effect on the predicted price (expected value). It is measured as the absolute value of the difference in expected value with and without an individual observation included in the estimation. Observations with a Cook's distance larger than the critical value is be dropped from the estimation. The critical value can be decided by a grid search maximizing the adjusted coefficient of determination. However, a grid search is not included in Stata. In step 203, the regression parameters can be estimated by using two different iteration processes (Huber and biweighting). The method can be seen as a WLS (weighted least square) method where observation with a high leverage and outliers is handled. If the errors are not normally distributed, WLS is more efficient than OLS. The step 205, which has not been implemented in Stata, is an evaluation process in which the preferred estimation process (in this case handling leverage and outliers) is determined. In the testing procedure, a traditional OLS (ordinary least square) model including all observations is compared to an OLS model excluding observation with a high leverage. The exclusion is in accordance with one embodiment based on the 1^{st} and the 99^{th} percentile on each independent variable and observation with a lower value than the 1^{st} percentile or higher than the 99^{th} percentile is excluded. Moreover, the two OLS models are compared to the WLS model, described above, using an out-of-sample prediction test. The out-of-sample test uses the first 80 percent of the observations in order to predict the price of the last 20 percent. The sample is a random sample with equal probability. This procedure has been carried out 10 times; hence, a new sample has been estimated 10 times and all parameters have been estimated and a price predicted. The model with the lowest RMSE (root mean square error) is in accordance with one embodiment chosen as estimation method.

1.-27. (canceled)

28. A method of automatically generating a housing price index, comprising:
receiving, in a receiving unit, transaction data relating to sales of at least one of houses and apartments,
generating, in a generating unit, a hedonic price index based on received transaction data for a specified period, and
continuously determining an estimate of the hedonic price index for the current period based on received new transaction data.

29. The method of claim 28, wherein the determined hedonic price index estimate is disseminated in real time.

30. The method of claim 28, wherein the period corresponds to a month, and the determined hedonic price index estimate is determined at least once every day.

31. The method of claim 28, wherein received transaction data is modeled taking into account observations determined to have high leverage and/or outliers.

32. A method of automatically generating a housing price index for a city, comprising:
receiving, in a receiving unit, transaction data relating to sales of at least one of houses and apartments,
generating, in a generating unit, a hedonic price index based on received transaction data for a specified period, and
including, as a parameter in generating the hedonic price index, a distance to a center of the city.

33. The method of claim 32, wherein the center is determined from data relating to transactions.

34. The method of claim 32, wherein at least one of the following parameters are included in generating the hedonic price index: sub-market, distance to sub-market center, direction from center, direction from sub-market center, parish, and administrative area.

35. The method of claim 32, wherein transaction data used for generating the hedonic price index is expanded by including at least one of data from a neighboring area and older data.

36. The method of claim 35, wherein the transaction data is expanded only if a size of a set of transaction data is smaller than a predetermined number.

37. The method of claim 36, wherein the set of transaction data is determined to be small if a confidence interval for the generated hedonic price index is larger than a pre-determined value.

38. A method of automatically generating a housing price index, comprising:
receiving, in a receiving unit, transaction data relating to sales of at least one of houses and apartments, and
generating, in a generating unit, a hedonic price index based on received transaction data for a specified period, wherein the hedonic price index is generated using moving window regression.

39. The method of claim 38, wherein the moving window moves over a fixed period determining parameter values for the hedonic price index based on transactions during the fixed period.

40. The method of claim 39, wherein the fixed period is twelve months, and the parameter values are updated once every month.

41. A computer system for automated generation of a housing price index, comprising:
a receiving unit configured for receiving transaction data relating to sales of at least one of houses and apartments, and
a generating unit configured for generating a hedonic price index based on received transaction data for a specified period, and for continuously determining an estimate of the hedonic price index for a current period based on received new transaction data.

42. The system of claim 41, further comprising a dissemination unit configured for disseminating the hedonic price index estimate in real time.

43. The system of claim 41, wherein the period corresponds to a month, and the hedonic price index estimate is determined at least once every day.

44. The system of claim 41, further comprising a modeler configured for modeling received data taking into account observations determined to have high leverage and/or outliers.

45. A computer system for automated generation of a housing price index for a city, comprising:
a receiving unit configured for receiving transaction data relating to sales of at least one of houses and apartments,
a generating unit configured for generating a hedonic price index based on received transaction data for a specified period, and for including, as a parameter in generating the hedonic price index, a distance to the center of the city.

46. The system of claim 45, further comprising a distance device configured for determining the center from data relating to transactions.

47. The system of claim 45, wherein at least one of the following parameters are included in generating the hedonic price index: sub-market, distance to sub-market center, direction from center, direction from sub-market center, parish, and administrative area.

48. The system of claim 45, wherein the generating unit uses expanded data based on at least one of a neighboring area and older data.

49. The system of claim 48, wherein the generating unit uses expanded data when a size of a set of data is smaller than a pre-determined number.

50. The system of claim 49, wherein the system is configured to determine the set of data to be small if a confidence interval for the generated hedonic price index is larger than a pre-determined value.

51. A computer system for automated generation of a housing price index, comprising:
a receiving unit configured for receiving transaction data relating to sales of at least one of houses and apartments, and
a generating unit configured for generating a hedonic price index based on received transaction data for a specified period using moving window regression.

52. The system of claim 51, wherein the generating unit moves the moving window over a fixed period and determines parameter values for the hedonic price index based on the transactions taking place during the fixed period.

53. The system of claim 52, wherein the fixed period is twelve months, and the parameter values are updated once every month.

54. A method of generating a housing price index for an area, comprising:
combining, in a combining unit, information about long-term development from a first area with information about short-term-development for at least one of a correlated larger area and a cluster of correlated areas, and
estimating, in an estimating unit, at least one of a short-term development and a long-term development of the housing price index for the first area based on combined information.
